(19) United States
(12) Patent Application Publication
(10) Pub. No.: US 2014/0030602 A1
(43) Pub. Date: Jan. 30, 2014

(54) CATHODE ACTIVE MATERIAL FOR LITHIUM SECONDARY BATTERY, METHOD OF MANUFACTURING THE SAME, AND LITHIUM SECONDARY BATTERY INCLUDING THE SAME

(71) Applicants: SEJIN INNOTECH CO., LTD., Ulsan (KR); UNIST Academy-Industry Research Corporation, Ulsan (KR)

(72) Inventors: Soojin Park, Ulsan (KR); Jaephil Cho, Ulsan (KR); Hyun-Kon Song, Ulsan (KR)

(73) Assignees: SEJIN INNOTECH CO., LTD., Ulsan (KR); UNIST Academy-Industry Research Corporation, Ulsan (KR)

(21) Appl. No.: 14/037,615

(22) Filed: Sep. 26, 2013

Related U.S. Application Data
(63) Continuation of application No. PCT/KR2011/003096, filed on Apr. 27, 2011.

(30) Foreign Application Priority Data
Apr. 15, 2011 (KR) 10-2011-0035286

(51) Int. Cl. H01M 4/38

(52) U.S. Cl. CPC H01M 4/386
USPC 429/231.95; 216/13

(57) ABSTRACT

Disclosed are an anode active material for a lithium secondary battery, including a material doping and dedoping lithium, and a plurality of external pores having a size of 0.1 to 3 μm formed in a surface of the material doping and dedoping lithium, the material doping and dedoping lithium including Si, a method of manufacturing the same, and a lithium secondary battery including the same.

### CROSS-REFERENCE TO RELATED APPLICATION

This application is a continuation application of International Application No. PCT/KR2011/003096 filed on Apr. 27, 2011, which claims priority to Korean Patent Application No. 10-2011-0035286, filed on Apr. 15, 2011, the entire contents of which are incorporated herein by reference.

### BACKGROUND OF THE INVENTION

(a) Field of the Invention

The present invention relates to an anode active material for a lithium secondary battery, a method of manufacturing the same, and a lithium secondary battery including the same.

(b) Description of the Related Art

In an initial lithium secondary battery, lithium metal is frequently used as an anode material. Lithium metal has a merit in that a high capacity is obtained. However, a dendrite type growth occurs due to dissolution or precipitation by ionization of lithium metal according to a repetition of charging and discharging. Accordingly, an internal short circuit occurs in the battery, and thus a problem regarding stability of the battery largely comes to the fore. Further, when lithium metal is exposed to water, an intense exothermic reaction occurs. Accordingly, careful management is required during a handling process, thus causing many restrictions during a mass production process in practice.

In order to overcome the aforementioned problems, a carbon material, such as graphite, as the anode material has been researched. An electrochemical reaction potential of the carbon-based anode material with lithium ions is very close to that of lithium metal, and a change in crystalline structure is small during an insertion/elimination process of the lithium ions. Accordingly, continuous and repetitive oxidation/reduction reactions can be performed at an electrode, thus providing a base for a capacity and an excellent lifespan of the lithium secondary battery.

However, currently, in accordance with a reduction in weight and size and multi-functionalization of portable equipment to which the lithium secondary battery is applied, a battery energy density as a power supply should be improved in order to satisfy a long operation time. However, until now, in the case of commercially available graphite, a theoretical storage capacity (based on LiC6) of lithium is limited to 372 mAh/g (or 820 mAh/cm³). Accordingly, an anode active material having a larger lithium storage capacity is required in order to overcome the problem.

Metallic or intermetallic compound-based anode active materials as the anode active material having a high capacity other than graphite have been actively researched. For example, a lithium battery using metal such as aluminum, germanium, silicon, tin, zinc, and lead, or semimetal as an anode active material is researched. The material has a high capacity and a high energy density and can absorb and emit lithium ions in a larger quantity as compared to the anode active material using the carbon-based material. Accordingly, the material is considered to be capable of forming a battery having a high capacity and a high energy density. It is known that among the materials, pure silicon has a high theoretical capacity of 4200 mAh/g.

However, since silicon has a reduced cycle characteristic as compared to the carbon-based material, silicon is an impediment in commercialization. The reason is because when inorganic particles, such as silicon, as the anode active material are used as a material absorbing and emitting lithium, conductivity between the active materials is reduced or the anode active material is stripped from an anode collector due to a change in volume during a charging/discharging process.

The inorganic particles such as silicon included in the anode active material absorb lithium due to charging to expand 300% or more in terms of volume. In addition, when lithium is emitted due to discharging, silicon shrinks. When the charging/discharging cycle is repeated, electric insulation may occur, and thus the battery has a characteristic of a rapid reduction in lifespan. Accordingly, silicon has a serious problem in use in the lithium battery.

In order to overcome the aforementioned problem, a research for ensuring a buffer effect to a change in volume by using particles having a nano-level size or allowing silicon to have porosity, and a research for overcoming a reduction in electric conductivtiy according to a use of inactive metal and providing an excellent electrochemical characteristic by minimizing a volume expansion due to metal have been conducted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a anode active material for a lithium secondary battery, a method of manufacturing the same, and a lithium secondary battery including the same.

An exemplary embodiment of the present invention provides a anode active material for a lithium secondary battery. The anode active material includes a material doping and dedoping lithium. A plurality of external pores having a size of 0.1 to 3 μm is formed in a surface of the material doping and dedoping lithium. The material doping and dedoping lithium includes Si.

A plurality of external pores may include internal pores having a size of 10 to 50 nm.

The adjacent external pores of a portion of the plurality of external pores may be connected to each other to allow the surface of the material doping and dedoping lithium to have a shape of a wire.

A length of the wire may be 100 nm to 1 μm.

A BET specific surface area of the anode active material for the lithium secondary battery may be 2.0 to 20.0 m²/g.

A total pore volume of the anode active material for the lithium secondary battery may be 0.03 to 0.06 cc/g.

Another exemplary embodiment of the present invention provides a method of manufacturing a anode active material for a lithium secondary battery. The method includes preparing a material doping and dedoping lithium, depositing metal particles on a surface of the material doping and dedoping lithium, and forming pores in the surface of the material doping and dedoping lithium by etching the surface on which the metal particles are deposited.

The material doping and dedoping lithium may include Si.

The depositing of the metal particles on the surface of the material doping and dedoping lithium, and the forming of the pores in the surface of the material doping and dedoping lithium by etching the surface on which the metal particles are deposited may be performed simultaneously.

In the forming of the pores in the surface of the material doping and dedoping lithium by etching the surface on which the metal particles are deposited, the pores may include external pores formed in the surface of the material doping and dedoping lithium and internal pores formed in the external pores.

Sizes of the external pores may be 0.1 to 3 μm.

Sizes of the internal pores may be 10 to 50 μm.

The adjacent pores of a portion of the pores formed by the forming of the pores in the surface of the material doping and dedoping lithium may be connected to each other to allow the surface of the material doping and dedoping lithium to have a shape of a wire.

A length of the wire may be 100 nm to 1 μm.

A BET specific surface area of the anode active material for the lithium secondary battery manufactured according to the method may be 2.0 to 20.0 m²/g.

A total pore volume of the anode active material for the lithium secondary battery manufactured according to the method may be 0.03 to 0.06 cc/g.

The depositing of the metal particles on the surface of the material doping and dedoping lithium may include adding the material doping and dedoping lithium to an aqueous solution including a metal catalyst agent and hydrogen fluoride.

A concentration of hydrogen fluoride may be 1 to 10M.

A concentration of the metal catalyst agent may be 0.1 to 50 mM.

The forming of the pores in the surface of the material doping and dedoping lithium by etching the surface on which the metal particles are deposited may include adding the material doping and dedoping lithium, on the surface of which the metal particles are deposited, to an aqueous solution including hydrogen fluoride and an oxidant.

A concentration of hydrogen fluoride may be 1 to 10M.

A concentration of the oxidant may be 0.1 to 2M.

The oxidant may be H₂O₂, Fe NO₃₃, KMnO₄, or a combination thereof.

Yet another exemplary embodiment of the present invention provides a lithium secondary battery including a cathode, and an anode including a collector and an anode active material layer formed on the collector. A separator is disposed between the cathode and the anode. An electrolyte is incorporated in the cathode, the anode, and the separator. The anode active material layer includes an anode active material. The anode active material includes a material doping and dedoping lithium, and a plurality of external pores having a size of 0.1 to 3 μm formed in a surface of the material doping and dedoping lithium. The material doping and dedoping lithium includes Si.

An initial capacity of the lithium secondary battery may be 2,000 mAh/g or more.

A coulombic efficiency of the lithium secondary battery may be 70% or more.

A coulombic efficiency of the lithium secondary battery may be 90% or more after a first cycle.

It is possible to provide a anode active material for a lithium secondary battery having small volume expansion during charging/discharging of the lithium secondary battery.

Further, it is possible to provide a method of manufacturing the anode active material for the lithium secondary battery, which facilitates mass production and has a simple process.

Further, it is possible to provide a lithium secondary battery having improved discharge C-rate capability and life-span characteristic using the anode active material for the lithium secondary battery.

### BRIEF DESCRIPTION OF THE DRAWINGS

FIG. 1 is a cross-sectional view of a anode active material for a lithium secondary battery according to an exemplary embodiment of the present invention.

FIG. 2 is a cross-sectional view of a anode active material for a lithium secondary battery according to another exemplary embodiment of the present invention.

FIG. 3 is a schematic flowchart of a method of manufacturing a anode active material for a lithium secondary battery according to yet another exemplary embodiment of the present invention.

FIG. 4 is a SEM picture of a anode active material manufactured in Example 1 before coated with a carbon material.

FIG. 5 is a graph showing an external pore distribution of the anode active material according to Example 1.

FIG. 6 is a SEM picture of a anode active material manufactured in Example 2 before coated with the carbon material.

FIG. 7 is a graph showing an external pore distribution of the anode active material according to Example 2.

FIG. 8 is a SEM picture of a anode active material manufactured in Example 3 before coated with the carbon material.

FIG. 9 illustrates a battery characteristic evaluation result of half-cells manufactured in Examples 4 and 5 at 0.1 C.

FIG. 10 illustrates a cycle characteristic evaluation of the half-cells manufactured in Examples 4 and 5 at 0.1 C.

### DETAILED DESCRIPTION OF THE EMBODIMENTS

Hereinafter, an exemplary embodiment of the present invention will be described in detail. However, the exemplary embodiment is illustrative only but is not to be construed to limit the present invention, and the present invention is just defined by the scope of the claims as described below.

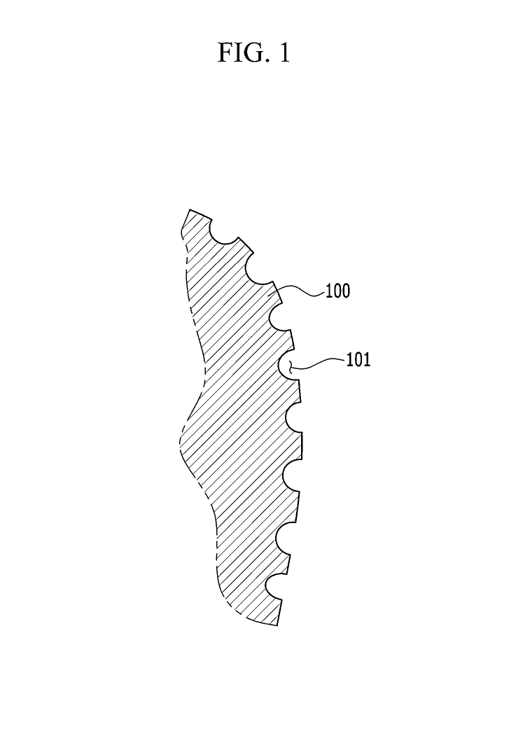

FIG. 1 is a cross-sectional view of a anode active material for a lithium secondary battery according to an exemplary embodiment of the present invention. Referring to FIG. 1, the anode active material for the lithium secondary battery according to the exemplary embodiment of the present invention will be described.

The anode active material for the lithium secondary battery according to the exemplary embodiment of the present invention may include a material 100 doping and dedoping lithium, and a plurality of external pores 101 having a size of 0.1 to 3 μm formed in a surface of the material 100 doping and dedoping lithium. The material 100 doping and dedoping lithium may include Si.

As described above, in the case of the Si-based anode active material for the lithium secondary battery including the external pores 101, volume expansion of the anode active material may be suppressed during charging and/or discharging due to the external pores 101. A cycle characteristic of the lithium secondary battery including the anode active material may be improved.

Further, a surface area of the anode active material for the lithium secondary battery may be increased due to the presence of the external pores 101 to increase a contact area with an electrolyte. The lithium secondary battery including the anode active material may have improved discharge C-rate capability.

A plurality of external pores 101 may include internal pores (not shown) having a size of 10 to 50 nm. The surface area of the anode active material may be further improved due to the presence of the internal pores.

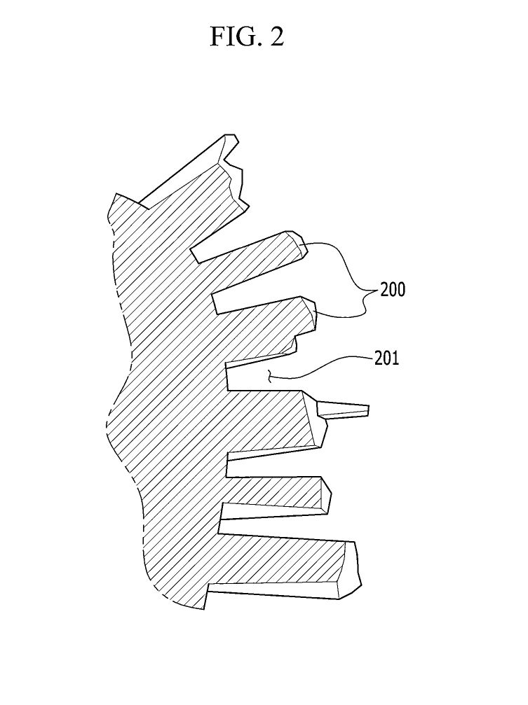

FIG. 2 is a cross-sectional view of a anode active material for a lithium secondary battery according to another exemplary embodiment of the present invention.

The anode active material for the lithium secondary battery according to another exemplary embodiment of the present invention shown in FIG. 2 may be a material where adjacent external pores 201 of a portion of a plurality of external pores 101 of the anode active material for the lithium secondary battery according to the exemplary embodiment of the present invention shown in FIG. 1 are connected to each other to allow the surface of the material doping and dedoping lithium to have a shape of a wire 200.

A surface of the wire 200 may include a plurality of internal pores (not shown).

The anode active material for the lithium secondary battery having the wire 200 shape in the surface thereof according to the exemplary embodiment of the present invention, as described above, has a small volume change during charging and/or discharging and a large surface area. An effect caused by the aforementioned constitution is the same as the aforementioned effect, and thus will be omitted.

A length of the wire 200 may be 100 nm to 1 μm, and more specifically 200 to 500 nm. The length of the wire 200 may depend on an etching condition of the material 100 doping and dedoping lithium including Si, and is not limited to the aforementioned range. The aforementioned range is a range suitable to satisfy the aforementioned effect.

A BET specific surface area of the anode active material for the lithium secondary battery may be 2.0 to 20.0 m²/g, and more specifically 2.35 to 18.11 m²/g. When the lithium secondary battery is manufactured using the anode active material satisfying the aforementioned range, discharge C-rate capability of the lithium secondary battery may be improved.

A total pore volume of the anode active material for the lithium secondary battery may be 0.03 to 0.06 cc/g, and more specifically 0.0379 to 0.0574 cc/g.

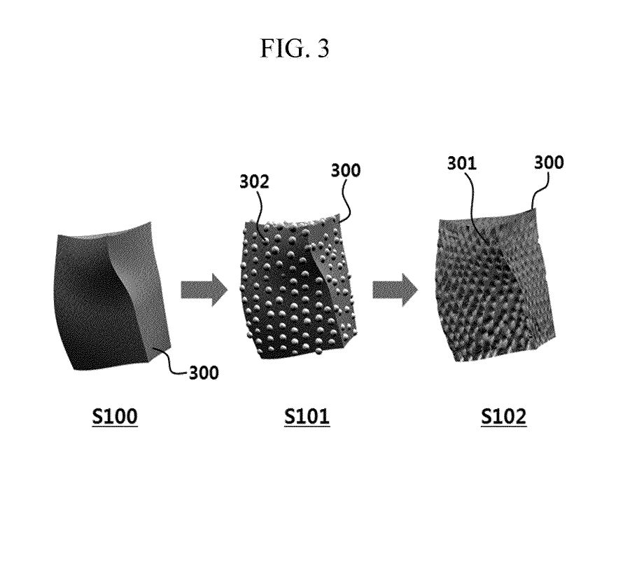

FIG. 3 is a schematic flowchart of a method of manufacturing a anode active material for a lithium secondary battery according to yet another exemplary embodiment of the present invention. The method of manufacturing the anode active material for the lithium secondary battery according to yet another exemplary embodiment of the present invention will be described with reference to FIG. 3.

The method of manufacturing the anode active material for the lithium secondary battery according to yet another exemplary embodiment of the present invention may include preparing a material 300 doping and dedoping lithium S100; depositing metal particles 302 on a surface of the material 300 doping and dedoping lithium S101; and forming pores 301 in the surface of the material 300 doping and dedoping lithium by etching the surface on which the metal particles 302 are deposited S102.

As described in the aforementioned anode active material for the lithium secondary battery according to the exemplary embodiment of the present invention, the material 300 doping and dedoping lithium may include Si.

In the forming of the pores in the surface of the material doping and dedoping lithium by etching the surface on which the metal particles are deposited S102, the pores 301 may include external pores formed in the surface of the material 300 doping and dedoping lithium and internal pores formed in the external pores. The description of the external pores and the internal pores is the same as the description of the aforementioned anode active material for the lithium secondary battery according to the exemplary embodiment of the present invention.

Further, the adjacent pores 301 of a portion of the pores 301 may be connected to each other to allow the surface of the material 300 doping and dedoping lithium to have a shape of a wire. The description of the wire form is the same as the description of the aforementioned anode active material for the lithium secondary battery according to the exemplary embodiment of the present invention.

Further, the anode active material by the method of manufacturing the anode active material for the lithium secondary battery according to yet another exemplary embodiment of the present invention may have the BET specific surface area and the pore volume described in the aforementioned anode active material for the lithium secondary battery according to the exemplary embodiment of the present invention. The description thereof is the same as that of the aforementioned anode active material for the lithium secondary battery according to the exemplary embodiment of the present invention, and thus will be omitted.

Examples of the material 300 doping and dedoping lithium may include Si, SiOx (0<x<2), Si-Q alloy (Q is alkali metal, alkali earth metal, Group 13 to Group 16 elements, transition metal, rare earth elements, or a combination thereof, but not Si), Sn, SnO₂, and Sn—R (R is alkali metal, alkali earth metal, Group 13 to Group 16 elements, transition metal, rare earth elements, or a combination thereof, but not Sn), and at least one thereof and SiO₂ may be mixed and used. Examples of specific elements of Q and R may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. Examples of the transition metal oxides may include vanadium oxides and lithium vanadium oxides.

Further, the material 300 doping and dedoping lithium may include Si.

The depositing of the metal particles 302 on the surface of the material 300 doping and dedoping lithium according to the exemplary embodiment of the present invention S101 may be performed using an electroless plating method.

The metal particles 302 may be Ag, Au, Cu, Pt, or a combination thereof, but are not limited thereto.

The forming of the pores 301 in the surface of the material 300 doping and dedoping lithium by etching the surface on which the metal particles 302 are deposited S102 may be performed using a catalytic etching method.

The depositing of the metal particles 302 on the surface of the material 300 doping and dedoping lithium S101, and the forming of the pores 301 in the surface of the material 300 doping and dedoping lithium by etching the surface on which the metal particles 302 are deposited S102 may be performed simultaneously.

The depositing of the metal particles 302 on the surface of the material 300 doping and dedoping lithium S101 may include adding the material 300 doping and dedoping lithium to an aqueous solution including a metal catalyst agent and hydrogen fluoride.

The metal catalyst agent may be a salt form of Ag, Au, Cu, or Pt, which is metal included in the metal particles 302, or a combination thereof. Anions of the salt may be nitric acids (NO₃), sulfuric acids (SO₄²⁻), iodine (I⁻), perchloric acids (ClO₄⁻), acetic acids (CH₃COO⁻) or a combination thereof.

A concentration of hydrogen fluoride may be 1 to 10M, and the concentration of the metal catalyst agent may be 0.1 to 50 mM.

A reaction time may be 1 to 10 min, and a reaction temperature may be 10 to 80° C.

The forming of the pores in the surface of the material 300 doping and dedoping lithium by etching the surface on which the metal particles 302 are deposited may include adding the material 300 doping and dedoping lithium, on the surface of which the metal particles 302 are deposited, to an aqueous solution including hydrogen fluoride and an oxidant.

The aforementioned step is a step for catalytic etching.

The concentration of hydrogen fluoride may be 1 to 10M, and the concentration of the oxidant may be 0.1 to 2M or 0.1 to 1.5M.

The reaction time may be 1 to 15 hours, and the reaction temperature may be 20 to 90° C.

The degree of etching may be adjusted by adjusting the concentration range, and a size and a depth of the pore may be adjusted by adjusting the degree of etching. When the degree of etching is increased, the adjacent pores 301 (external pore) may be connected to manufacture the material 300 doping and dedoping lithium having the wire-shaped surface.

The oxidant may be H₂O₂, FeNO₃₃, KMnO₄, HNO₃, or a combination thereof. The degree of etching may depend on a type of the oxidant.

In order to specifically exemplify the reaction, on the supposition that the material 300 doping and dedoping lithium is Si, the metal particles are silver, and the oxidant is H₂O₂, the reaction will be described.

Si+2H₂O₂+6HF→H₂SiF₆+4H₂O [Reaction Equation 1]

As shown in Reaction Equation 1, the reaction of Reaction Equation 1 occurs at a portion at which silicon and silver are in contact with each other, and silver acts as a catalyst to etch silicon. Accordingly, silver is vertically etched along a silicon substrate. The reaction of Reaction Equation 1 does not occur at a portion at which silicon and silver are not in contact with each other. Accordingly, etching is not performed to form the pores in the surface of the silicon particles.

Further, for example, specifically, in the case of H₂O₂ among the oxidants, the inside of the pores 301 (external pore) formed by etching may be additionally etched while a portion on which the metal particles 302 are deposited is etched, thus forming the internal pores.

Further, for example, specifically, in the case of FeNO₃₃ among the oxidants, the portion on which the metal particles 302 are deposited may be etched so that the surface has the shape of the wire. Additional etching may not be performed after etching of the shape of the wire, thus not forming the internal pores.

When the depositing of the metal particles 302 on the surface of the material 300 doping and dedoping lithium and the forming of the pores 301 in the surface of the material 300 doping and dedoping lithium by etching the surface on which the metal particles 302 are deposited are performed simultaneously, the metal catalyst agent may be a silver nitrate aqueous solution.

Alternatively, when the depositing of the metal particles 302 on the surface of the material 300 doping and dedoping lithium and the forming of the pores 301 in the surface of the material 300 doping and dedoping lithium by etching the surface on which the metal particles 302 are deposited are performed simultaneously, hydrogen fluoride, the metal catalyst agent, and the oxidant may be added simultaneously to perform the reaction. In this case, both the metal catalyst agent and the oxidant may be a silver nitrate aqueous solution.

In this case, the concentration of hydrogen fluoride may be 1 to 15M. Further, the concentration of the oxidant (e.g., silver nitrate) may be 1 to 30 mM. Further, the reaction time of the reaction may be 0.5 to 15 hours, and the reaction temperature may be 10 to 90° C.

Yet another exemplary embodiment of the present invention provides a lithium secondary battery including a cathode, an anode including a collector and an anode active material layer formed on the collector, a separator disposed between the cathode and the anode, and an electrolyte incorporated in the cathode, the anode, and the separator. The anode active material layer includes an anode active material. The anode active material includes a material doping and dedoping lithium, and a plurality of external pores having a size of 0.1 to 3 μm formed in a surface of the material doping and dedoping lithium. The material doping and dedoping lithium includes Si.

The description of the anode active material is the same as that of the aforementioned anode active material for the lithium secondary battery according to the exemplary embodiment of the present invention, and thus will be omitted.

An initial capacity of the lithium secondary battery may be 2,000 mAh/g or more.

Further, a coulombic efficiency of the lithium secondary battery may be 70% or more.

The coulombic efficiency of the lithium secondary battery may be 90% or more after a first cycle.

When the anode active material for the lithium secondary battery according to the exemplary embodiment of the present invention is included, the lithium secondary battery may satisfy the initial capacity, the coulombic efficiency, and the cycle characteristic.

The description of the aforementioned anode active material for the lithium secondary battery is a description of a portion of constitutions of the lithium secondary battery.

The lithium secondary battery may be classified into a lithium ion battery, a lithium ion polymer battery, and a lithium polymer battery according to a type of the used separator and electrolyte. The lithium secondary battery may be classified into a cylindrical type, a square type, a coin type, and a pouch type according to a shape, and a bulk type and a thin film type according to a size. Since the structure and the manufacturing method of the batteries are widely known in the art, a detailed description thereof will be omitted.

The anode includes the collector and the anode active material layer formed on the collector. The anode active material layer includes the anode active material.

The anode active material may be the aforementioned anode active material according to the exemplary embodiment of the present invention.

The anode active material layer also includes a binder, and may further selectively include a conductive material.

The binder acts to attach the anode active material particles well to each other and also attach the anode active material to a current collector well. As representative examples thereof, polyvinyl alcohol, carboxymethyl cellulose, hydroxypropyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon may be used, but the examples are not limited thereto.

The conductive material is used to provide conductivity to the electrode. Any conductive material may be used as long as the conductive material does not cause a chemical change in the constituted battery and is an electronic conductive material. As examples thereof, a conductive material including a carbon-based material such as natural graphite, artificial graphite, carbon black, acetylene black, Ketjen black, and carbon fibers; a metal-based material such as metal powder or metal fibers such as copper, nickel, aluminum, and silver; a conductive polymer such as a polyphenylene derivative; or a mixture thereof may be used.

As the collector, a copper foil, a nickel foil, a stainless steel foil, a titanium foil, a nickel foam, a copper foam, a polymer base on which conductive metal is applied, or a combination thereof may be used.

The cathode includes a current collector and a cathode active material layer formed on the current collector.

As a cathode active material, a compound where reversible intercalation and diintercalation of lithium can occur (lithiated intercalation compound) may be used. Specifically, one type or more of complex oxides of metal of cobalt, manganese, nickel, or a combination thereof and lithium may be used. As specific examples thereof, a compound represented by any one of the following Chemical Formulas may be used.

LiₐA_{1-b}R_{b}D₂ (where, 0.90≦a≦1.8 and 0≦b≦0.5); LiₐE_{1-b}RbO_{2-c}D_{c} (where, 0.90≦a≦1.8, 0≦b≦0.5, and 0≦c≦0.05); LiE_{2-b}RbO_{4-c}D_{c} (where, 0≦b≦0.5 and 0≦c≦0.05); LiₐNi_{1-b-c}Co_{b}R_{c}D_{α} (where, 0.90≦a≦1.8, 0≦b≦0.5, 0≦c≦0.05, and 0<α≦2); LiₐNi_{1-b-c}Co_{b}R_{c}O_{2-α}Z_{α} (where, 0.90≦a≦1.8, 0≦b≦0.5, 0≦c≦0.05, and 0<α≦2); LiₐNi_{1-b-c}Co_{b}R_{c}O_{2-α}Z₂ (where, 0.90≦a≦1.8, 0≦b≦0.5, 0≦c≦0.05, and 0<α<2); LiₐNi_{1-b-c}Mn_{b}R_{c}D_{α} (where, 0.90≦a≦1.8, 0≦b≦0.5, 0≦c≦0.05, and 0<α≦2); LiₐNi_{1-b-c}Mn_{b}R_{c}O_{2-α}Zₐ (where, 0.90<a≦1.8, 0≦b≦0.5, 0≦c≦0.05, and 0<α<2); LiₐNi_{1-b-c}Mn_{b}R_{c}O_{2-α}Z₂ (where, 0.90≦a≦1.8, 0≦b≦0.5, 0≦c≦0.05, and 0≦α≦2); LiₐNi_{b}E_{c}G_{d}O₂ (where, 0.90≦a≦1.8, 0≦b≦0.9, 0≦c≦0.5, and 0.001≦d≦0.1); LiₐNi_{b}Co_{c}Mn_{d}GeO₂ (where, 0.90≦a≦1.8, 0≦b≦0.9, 0≦c≦0.5, 0≦d≦0.5, and 0.001≦e≦0.1); LiₐNiG_{b}O₂ (where, 0.90≦a≦1.8 and 0.001≦b≦0.1); LiₐCoG_{b}O₂ (where, 0.90≦a≦1.8 and 0.001≦b≦0.1); LiₐMnG_{b}O₂ (where, 0.90≦a≦1.8 and 0.001≦b≦0.1); LiₐMn₂ GbO₄ (where, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂ PO₄₃ (0≦f≦2); Li_{(3-f)}Fe₂ PO₄₃ (0≦f≦2); and LiFePO₄.

In the Chemical Formulas, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

Needless to say, the compound having a coating layer on a surface thereof may be used, or the aforementioned compound and a compound having a coating layer may be mixed and used. The coating layer may include oxides, hydroxides, oxyhydroxides, oxycarbonates, or hydroxycarbonates of a coating element as a coating element compound. The compound forming the coating layers may be amorphous or crystalline. As the coating element included in the coating layer, Mg, Al, Co, K, Na, Ca, Si, Ti, V, Sn, Ge, Ga, B, As, Zr, or a mixture thereof may be used. Any coating method may be used in a process of forming the coating layer as long as coating can be performed according to the method (e.g., spray coating or an immersion method) not negatively affecting physical properties of the anode active material, in which the aforementioned elements are used with respect to the compound. This is a content fully understood by those who are skilled in the art, accordingly, a detailed description thereof will be omitted.

Further, the cathode active material layer includes the binder and the conductive material.

The binder acts to attach the cathode active material particles well to each other and also attach the anode active material to a current collector well. As representative examples thereof, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, and nylon may be used, but the examples are not limited thereto.

The conductive material is used to provide conductivity to the electrode. Any conductive material may be used as long as the conductive material does not cause a chemical change in the constituted battery and is an electronic conductive material. As examples thereof, natural graphite, artificial graphite, carbon black, acetylene black, Ketjen black, carbon fibers, and metal powder or metal fibers such as copper, nickel, aluminum, and silver may be used. Further, one type or more of a conductive polymer such as a polyphenylene derivative may be mixed and used.

Al may be used as the current collector, but the current collector is not limited thereto.

The anode and the cathode are each manufactured by mixing the active material, the conductive material, and the binding agent in a solvent to manufacture an active material composition, and applying the composition on the current collector. Since the manufacturing method of the electrode is widely known in the art, a detailed description thereof will be omitted in the present specification. N-methylpyrrolidone may be used as the solvent, but the solvent is not limited thereto.

The electrolyte includes a non-aqueous organic solvent and a lithium salt.

The non-aqueous organic solvent acts as a medium through which ions involved in an electrochemical reaction of the battery move.

Carbonate-based, ester-based, ether-based, ketone-based, alcohol-based, or aprotic solvents may be used as the non-aqueous organic solvent. As the carbonate-based solvent, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC) may be used. As the ester-based solvent, methyl acetate, ethyl acetate, n-propyl acetate, dimethyl acetate, methyl propionate, ethyl propionate, γ-butyrolactone, decanolide, valerolactone, mevalonolactone, and caprolactone may be used. As the ether-based solvent, dibutyl ether, tetraglyme, diglyme, dimethoxyethane, 2-methyltetrahydrofuran, and tetrahydrofuran may be used. As the ketone-based solvent, cyclohexanone may be used. Further, as the alcohol-based solvent, ethyl alcohol and isopropyl alcohol may be used. As the aprotic solvent, nitriles such as R—CN (R is a hydrocarbon group having a C2 to C20 straight chain, branched chain, or cyclic structure, and may include a cycle in a double bond direction or an ether bond), amides such as dimethylformamide, dioxolanes such as 1,3-dioxolane, and sulfolanes may be used.

The non-aqueous organic solvent may be used alone or one or more non-aqueous organic solvents may be mixed and used. When one or more non-aqueous organic solvents are mixed and used, a mixing ratio may be appropriately adjusted according to a target battery performance, which may be fully understood to those who are skilled in the art.

Further, in the case of the carbonate-based solvent, it is preferable that cyclic carbonate and a chain-type carbonate be mixed and used. In this case, when cyclic carbonate and the chain-type carbonate are mixed at a volume ratio of about 1:1 to about 1:9 and used, performance of an electrolyte solution may be excellent.

The non-aqueous organic solvent may further include an aromatic hydrocarbon-based organic solvent in addition to the carbonate-based solvent.

In this case, the carbonate-based solvent and the aromatic hydrocarbon-based organic solvent may be mixed at a volume ratio of about 1:1 to about 30:1.

The aromatic hydrocarbon-based compound of the following Chemical Formula 1 may be used as the aromatic hydrocarbon-based organic solvent.

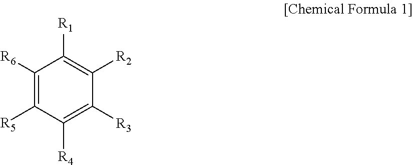

(in Chemical Formula 1, R₁ to R₆ are each independently hydrogen, a halogen, a C1 to C10 alkyl group, a C1 to C10 haloalkyl group, or a combination thereof)

As the aromatic hydrocarbon-based organic solvent, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof may be used.

The non-aqueous electrolyte may further include vinylene carbonate or an ethylene carbonate-based compound of the following Chemical Formula 2 in order to improve a life-span of the battery.

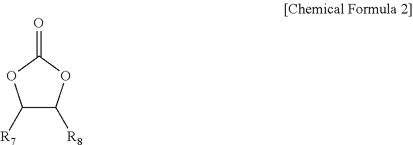

(in Chemical Formula 2, R₇ and R₈ are each independently hydrogen, a halogen group, a cyano group (CN), a nitro group (NO₂), or a C1 to C5 fluoroalkyl group, and at least one of R₇ and R₈ is a halogen group, a cyano group (CN), a nitro group (NO₂), or a C1 to C5 fluoroalkyl group)

Representative examples of the ethylene carbonate-based compound may include difluoroethylene carbonate, chloroethylene carbonate, dichloroethylene carbonate, bromoethylene carbonate, dibromoethylene carbonate, nitroethylene carbonate, cyanoethylene carbonate, and fluoroethylene carbonate. When vinylene carbonate or the ethylene carbonate-based compound is further used, a use amount thereof may be appropriately adjusted to improve the life-span.

The lithium salt is a material dissolved in the non-aqueous organic solvent to act as a supply source of lithium ions in the battery, thus facilitating a basic operation of the lithium secondary battery and promoting movement of the lithium ions between the cathode and the anode. Representative examples of the lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂, C_{y}F_{2y+1}SO₂) (where, x and y are a natural number), LiCl, Lil, LiB(C₂O₄)₂ (lithium bis(oxalato) borate; LiBOB), or a combination thereof, and include the examples as a supporting electrolytic salt.

It is preferable that the lithium salt be used in a concentration in the range of 0.1 to 2.0M. When the concentration of the lithium salt is included in the aforementioned range, the electrolyte has appropriate conductivity and viscosity. Accordingly, excellent electrolyte performance may be exhibited, and the lithium ions may effectively move.

A separator may be present between the cathode and the anode according to a type of lithium secondary battery. As the separator, polyethylene, polypropylene, polyvinylidene fluoride, or a multilayer of two or more layers thereof may be used. Needless to say, a mixed multilayer such as a polyethylene/polypropylene two-layered separator, a polyethylene/polypropylene/polyethylene three-layered separator, and a polypropylene/polyethylene/polypropylene three-layered separator may be used.

Hereinafter, specific Examples of the present invention will be suggested. However, the Examples described below are set forth to specifically illustrate or explain the present invention, but are not to be construed to limit the present invention.

### (Manufacturing of the Anode Active Material)

### Example 1

The solution where 5M hydrogen fluoride and 10 mM silver nitrate aqueous solution were mixed in the same volume was manufactured, and silicon in a powder state was immersed in the solution for about 5 min.

The silicon powder on which silver was applied in the aqueous solution state was washed several times through the aforementioned step to remove silver deposited in an excessive amount, filtered, and dried in a vacuum state at 150° C. for about 1 hour to manufacture the silicon powder on which silver was deposited.

Separately, the aqueous solution where 5M hydrogen fluoride and 1.3M hydrogen peroxide were mixed each in an amount of 60 mL was prepared. The prepared aqueous solution was appropriately mixed, and then heated in boiling water to increase the temperature thereof to 50° C. Thereafter, the silicon powder on which silver was applied was immersed for about 30 min to manufacture the anode active material having the pores selectively etched according to the catalytic etching method and having the size of about 1 μm.

The anode active material powder in the aqueous solution state was washed several times to remove remaining hydrogen fluoride, filtered, and dried in the vacuum state at 150° C. for about 1 hour.

After the temperature of the nitric acid was increased to 50° C. in order to remove silver remaining on the anode active material manufactured according to the aforementioned method, the anode active material was immersed for about 2 hours.

Thereafter, carbon coating was performed using acetylene gas at 900° C. In this case, the content of carbon was fixed to about 20 wt %.

### Example 2

The solution where 5M hydrogen fluoride and 10 mM silver nitrate aqueous solution were mixed in the same volume was manufactured, and silicon in a powder state was immersed for about 3 min and agitated.

Silver particles were deposited on the surface of silicon in the powder state through the aforementioned step. The silicon powder on which silver was deposited in the aqueous solution state was washed several times to remove silver deposited in an excessive amount, and then dried in the vacuum state at 150° C. for about 1 hour to manufacture the silicon powder on which silver was deposited.

Separately, the aqueous solution where 4.6M hydrogen fluoride and 0.135M iron nitrate (FeNO₃₃) were mixed each in an amount of 60 mL was prepared. The prepared aqueous solution was appropriately mixed, and then heated in boiling water to increase the temperature thereof to 70° C. Thereafter, the silicon powder on which silver was deposited was immersed for about 4 hours to manufacture the anode active material according to the catalytic etching method.

The anode active material in the aqueous solution state was washed several times to remove remaining hydrogen fluoride, filtered, and dried in the vacuum state at 150° C. for about 1 hour.

Thereafter, the temperature of the nitric acid was increased to 50° C. in order to remove silver remaining on the anode active material, and the anode active material was then immersed for about 2 hours.

Thereafter, carbon coating was performed using acetylene gas at 900° C. In this case, the content of carbon was fixed to about 20 wt %.

### Example 3

The aqueous solution where 5M hydrogen fluoride and 10 mM silver nitrate aqueous solution were mixed each in the same volume of 100 ml was prepared.

The prepared aqueous solution was appropriately mixed, and then heated in boiling water to increase the temperature thereof to 50° C. Thereafter, the prepared silicon powder was immersed and agitated for about 5 hours to manufacture the silicon powder according to an one-step manufacturing method improved as compared to the methods of Examples 1 and 2.

That is, the surface of the silicon powder was etched without a separate etching step.

The silicon powder in the aqueous solution state was washed several times to remove silver deposited in an excessive amount, filtered, and dried in the vacuum state at 150° C. for about 1 hour.

The temperature of the nitric acid was increased to 50° C. in order to remove silver remaining on the silicon powder manufactured according to the aforementioned method, and the silicon powder was then immersed for about 2 hours.

Thereafter, carbon coating was performed using acetylene gas at 900° C.

In this case, the content of carbon was fixed to about 20 wt %.

### (Manufacturing of the Half-Cell)

### Example 4

Manufacturing of the Anode

The anode active material manufactured in Example 1 was used, and the specific manufacturing method thereof is as follows.

1 g of the obtained silicon powder on which carbon was applied, 0.125 g of the carbon conductor (super P carbon black) having the average particle size of 5 to 10 μm, and 0.125 g of the polyvinylidene fluoride (PVDF, KF1100, Kureha Chemical Industry Co., Ltd. in Japan) conjugated body were mixed in the N-methylpyrrolidone (NMP, Aldrich) solution, and then applied on the copper foil (Cu foil) to manufacture the polar plate. The electrode slurry was mixed using the ultrasonic wave and the mixer for at least one hour, and then applied on the copper foil using doctor-blade coating of 70 μm. After drying at 70° C. for 1 hour, the polar plate having the thickness of 30 to 40 μm was manufactured.

Manufacturing of the Battery

The lithium thin film (0.9 mm thickness, Alfa Aesar, USA) was used as the counter electrode, and the silicon powder was used as the working electrode to manufacture the 2016-type coin cell.

The mixed solution of ethylene carbonate (EC), dimethyl carbonate (DMC), and diethylene carbonate (DEC), in which 1.0M LiPF₆ was dissolved, (3/4/3 volume ratio, Techno Semichem Co., Ltd., Korea) was used as the electrolyte solution to manufacture the battery.

### Example 5

The half-cell was manufactured according to the same method as Example 4, except that in Example 4, the anode active material manufactured in Example 2 was used instead of the anode active material manufactured in Example 1.

### Experimental Example

### SEM Picture

The shape of the surface of the anode active material manufactured in Example 1 was confirmed using the surface scanning electron microscope (SEM).

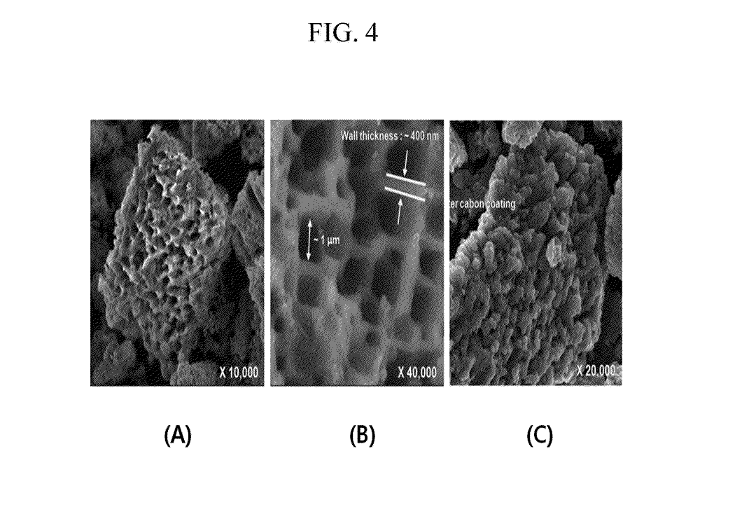

FIG. 4 is a SEM picture of the anode active material manufactured in Example 1 before coated with a carbon material.

In FIG. 4, A and B are SEM pictures magnified to 10000 and 40000 times before carbon coating in Example 1. As shown in A and B of FIG. 4, it can be seen that the external pores are formed in the surface of the anode active material.

C of FIG. 4 is a SEM picture (20000 magnification) after the anode active material manufactured in Example 1 is coated with carbon.

As shown in B of FIG. 4, it was confirmed that the average size of the external pores was about 1 μm and the wall thickness of the external pores was about 400 nm.

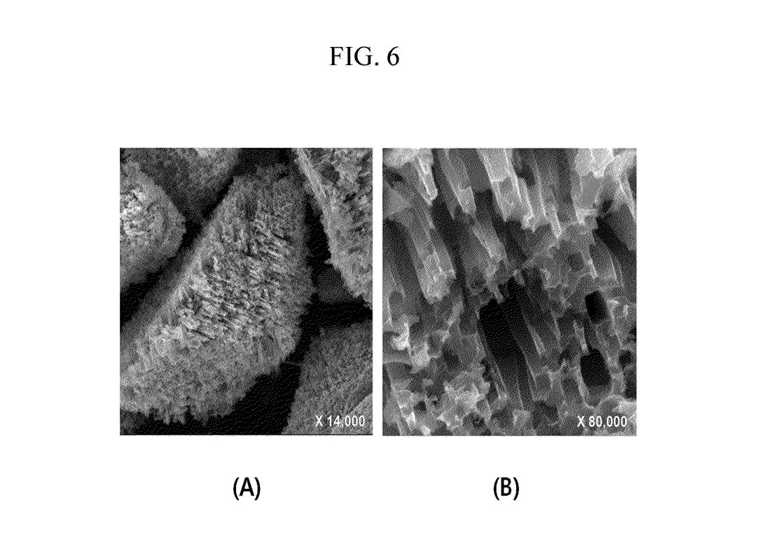

FIG. 6 is a SEM picture of the anode active material manufactured in Example 2 before coated with the carbon material.

As shown in A of FIG. 6, it could be confirmed that the wire having the length of about 1 μm was formed.

As described above, a manufacturing mechanism of the anode active material, on the surface of which the wire having the sea urchin shape is formed, is as follows.

The silver ions in the aqueous solution state are oxidized into metal silver on the silicon powder, deposited on the silicon powder, and transmit electrons to silicon to change silicon into silicon oxides. Further, Fe³⁺ of the iron nitrate in the aqueous solution state is reduced to be converted into Fe²⁺, and silicon oxides are etched by an HF aqueous solution. The aforementioned procedure is repeated to manufacture the silicon powder having the shape of the wire in the surface thereof.

B of FIG. 6 is a SEM picture obtained by expanding A of FIG. 6.

As shown in B of FIG. 6, it can be seen that the internal pores are not present in the surface of the wire unlike the anode active material manufactured in Example 1. This is judged because the oxidants used when the silicon powder is etched are different from each other.

When the silicon powder is etched according to the method of Example 1, re-etching of hydrogen peroxide used as the oxidant occurs to form the internal pores in the etched surface. On the other hand, in the method of manufacturing the silicon powder according to Example 2, the pores are judged to be not formed in the surface of the wire because the iron nitrate is used as the oxidant and re-etching due to the iron nitrate does not occur.

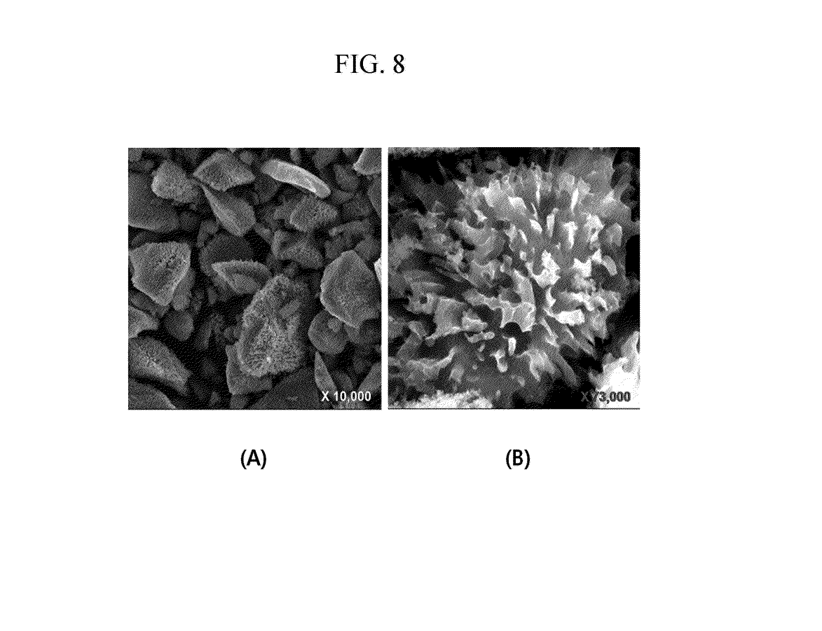

FIG. 8 is a SEM picture of the anode active material manufactured in Example 3 before coated with the carbon material.

As shown in A of FIG. 8, it could be confirmed that the wire was formed in the surface of the silicon powder.

As described above, the reason why the wires having the sea urchin shape are formed on the silicon powder is as follows.

First, the silver ions are reduced according to electroless plating to be converted into metal silver and deposited on the silicon powder, and silicon is converted into silicon oxides due to electrons generated when the silver ions are reduced. The converted silicon oxides are etched due to hydrogen fluoride.

The aforementioned procedure is repeated to form the wires having the sea urchin shape in the surface of the silicon powder.

As seen from B of FIG. 8, it was confirmed that the length of the wires was about 100 nm to 1 μm. The length can be adjusted according to an electroless plating condition (time and/or temperature).

In the aforementioned method, a manufacturing process is simple and a yield of about 60% or more can be obtained. Accordingly, it is judged that when the aforementioned powder is used as the anode active material of the lithium secondary battery, a manufacturing cost of the silicon-based anode active material can be reduced, and thus the aforementioned method is useful to mass production.

### Measurement of the Pore Distribution

The BET specific surface area, the pore volume, and the average pore size of the anode active material manufactured in Example 1 were measured.

The measurement method is as follows.

The BET (Brunauer-Emmett-Teller, VELSORP-mini II, BEL, Japan) specific surface area was measured at 77 K and a relative pressure (P/Po) in the range of 0.05 to 0.3 using a nitrogen adsorption and desorption method.

The pore volume was measured using a BJH (Barrett-Joyner-Halenda) plot, and calculated from the amount of nitrogen provided in the pores while the relative pressure (P/Po) was increased to 0.9.

The pore size distribution was measured from the same BJH plot at the relative pressure (P/Po) of 0.0002 to 0.9 to obtain the average pore size in the range of 2 to 100 nm.

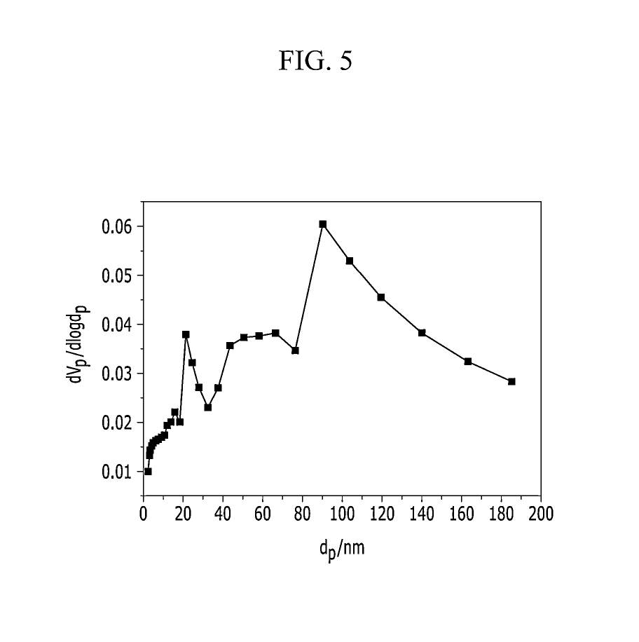

FIG. 5 is a graph showing an external pore distribution of the anode active material according to Example 1. In the following Table 1, the BET specific surface area, the pore volume, and the average pore size of the anode active material according to Example 1 are described.

TABLE 1

| BET specific surface area | Total pore volume | Average pore size |
|---|---|---|
| (m²/g) | (cc/g) | (nm) |
| 18.11 | 0.0574 | 12.67 |

In FIG. 5, dp/nm that is an x axis means the size of the pore present in the sample, and dVp/d log dp that an y axis means how many specific pore sizes are distributed.

The reason why a log value is used in the y axis is that the pore size distribution is very finely divided. The y axis may be represented without the log value.

As shown in FIG. 5, it was confirmed that the external pores and the internal pores were distributed with respect to the distribution of the pores.

The reason why the formed pores coexist is considered that the internal pores are formed due to re-etching caused by hydrogen peroxide used as the oxidant.

As described in Table 1, the BET specific surface area of the anode active material according to Example 1 measured about 18.11 m²/g, which is a result of the specific surface area improved as compared to that of typically used silicon powder.

The reason why the specific surface area is improved is that the external pores and the internal pores coexist as shown in the aforementioned pore size distribution view.

The BET specific surface area, the pore volume, and the average pore size of the anode active material manufactured in Example 2 were measured.

The measurement method is the same as the aforementioned method.

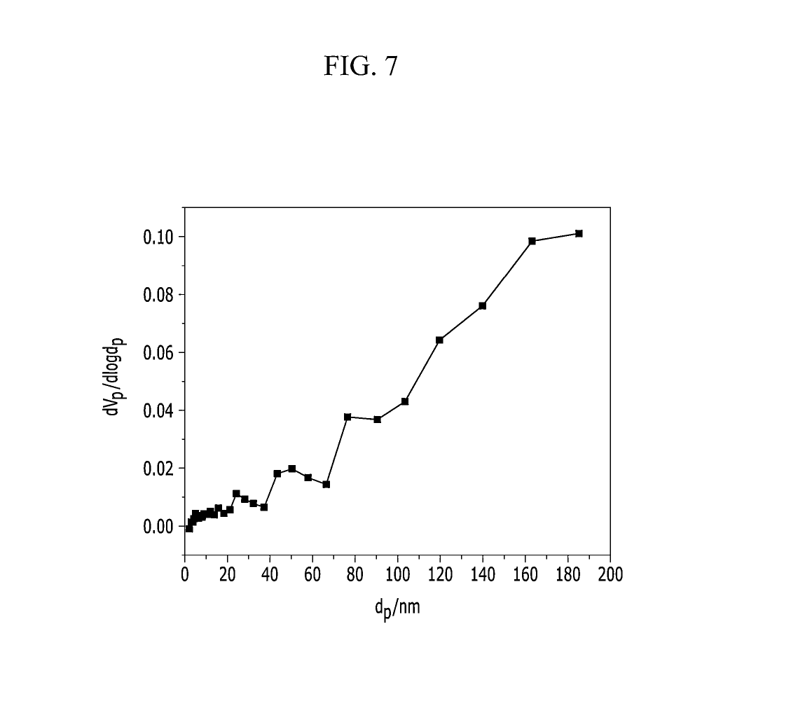

FIG. 7 is a graph showing the external pore distribution of the anode active material according to Example 2. In the following Table 2, the BET specific surface area, the pore volume, and the average pore size of the anode active material according to Example 2 are described.

TABLE 2

| BET specific surface area | Total pore volume | Average pore size |
|---|---|---|
| (m²/g) | (cc/g) | (nm) |
| 2.3574 | 0.0379 | 64.38 |

As seen from Table 2, it was confirmed that the anode active material according to Example 2 had the specific surface area of about 2.35 m²/g, which is a result of the specific surface area improved as compared to that of typically used silicon powder.

### Evaluation of the Half-Cell Characteristic

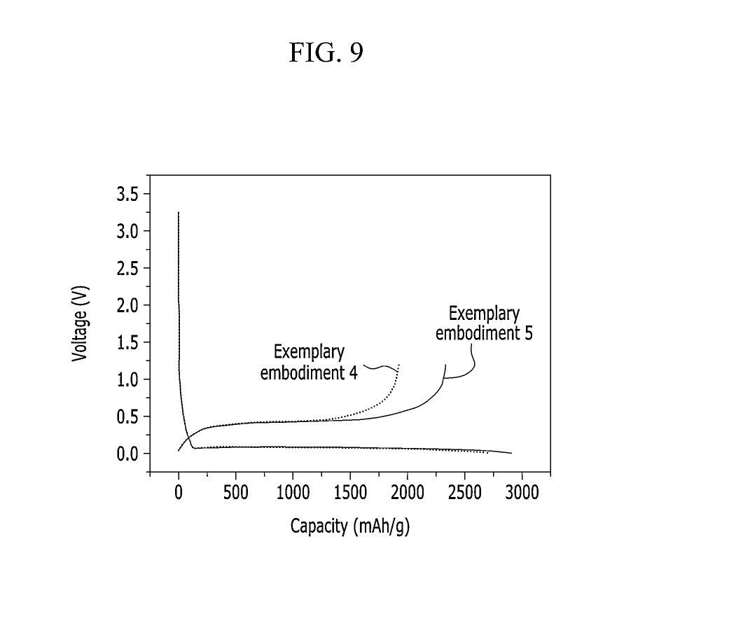

FIG. 9 illustrates a battery characteristic evaluation result of half-cells manufactured in Examples 4 and 5 at 0.1 C.

From FIG. 9, it can be seen that the half-cell according to Example 4 has the initial capacity of 2700 mAh/g and the half-cell according to Example 5 has the initial capacity of 2900 mAh/g.

Further, it can be seen that efficiency of the half-cell according to Example 4 is 71% and in the case of the half-cell according to Example 5, efficiency is about 80%.

Efficiency means how many lithium come out during charging (lithium delithiation) after initial discharging (lithium insertion). For example, when 100 lithium are inserted 100 lithium come out, efficiency may be considered to be 100%.

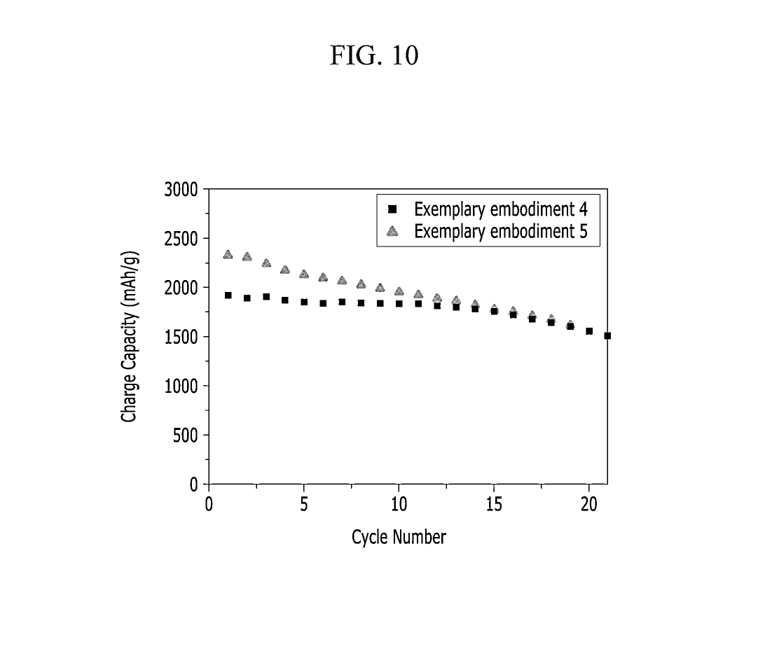

FIG. 10 illustrates a cycle characteristic evaluation of the half-cells manufactured in Examples 4 and 5 at 0.1 C.

From FIG. 10, it can be seen that efficiency is 95% or more after the first cycle in both Examples 4 and 5.

The reason why efficiency after a second cycle is increased as compared to initial efficiency is that there is a high probability of an occurrence of other side reactions in the battery during a period of initial efficiency, and it can be seen that efficiency is slightly increased after the period of initial efficiency.

Further, it can be seen that a capacity maintenance ratio is 80% or more after 20 cycles in both Examples 4 and 5.

The present invention is not limited to the aforementioned exemplary embodiments, but may be manufactured in various different forms, and it will be apparent to those skilled in the art that various modifications and changes may be made thereto without departing from the scope and spirit of the invention.

Therefore, it should be understood that the aforementioned exemplary embodiments are not limitative, but illustrative in all aspects.

### DESCRIPTION OF SYMBOLS

100: material doping and dedoping lithium
101: external pore
200: wire
201: external pore
300: material doping and dedoping lithium
301: pore
302: metal particle

What is claimed is:

1. An anode active material for a lithium secondary battery, comprising:
a material doping and dedoping lithium; and
a plurality of external pores having a size of 0.1 to 3 μm formed in a surface of the material doping and dedoping lithium,
wherein the material doping and dedoping lithium includes Si.

2. The anode active material of claim 1, wherein the plurality of external pores includes internal pores having a size of 10 to 50 nm.

3. The anode active material of claim 1, wherein the adjacent external pores of a portion of the plurality of external pores are connected to each other to allow the surface of the material doping and dedoping lithium to have a shape of a wire.

4. The anode active material of claim 3, wherein a length of the wire is 100 nm to 1 μm.

5. The anode active material of claim 1, wherein a BET specific surface area of the anode active material for the lithium secondary battery is 2.0 to 20.0 m²/g.

6. The anode active material of claim 1, wherein a total pore volume of the anode active material for the lithium secondary battery is 0.03 to 0.06 cc/g.

7. A method of manufacturing an anode active material for a lithium secondary battery, comprising:
preparing a material doping and dedoping lithium;
depositing metal particles on a surface of the material doping and dedoping lithium; and
forming pores in the surface of the material doping and dedoping lithium by etching the surface on which the metal particles are deposited.

8. The method of claim 7, wherein the material doping and dedoping lithium includes Si.

9. The method of claim 7, wherein the depositing of the metal particles on the surface of the material doping and dedoping lithium, and the forming of the pores in the surface of the material doping and dedoping lithium by etching the surface on which the metal particles are deposited are performed simultaneously.

10. The method of claim 7, wherein:
in the forming of the pores in the surface of the material doping and dedoping lithium by etching the surface on which the metal particles are deposited,
the pores include external pores formed in the surface of the material doping and dedoping lithium and internal pores formed in the external pores.

11. The method of claim 10, wherein sizes of the external pores are 0.1 to 3 μm.

12. The method of claim 10, wherein sizes of the internal pores are 10 to 50 μm.

13. The method of claim 7, wherein the adjacent pores of a portion of the pores formed by the forming of the pores in the surface of the material doping and dedoping lithium are connected to each other to allow the surface of the material doping and dedoping lithium to have a shape of a wire.

14. The method of claim 13, wherein a length of the wire is 100 nm to 1 μm.

15. The method of claim 7, wherein a BET specific surface area of the anode active material for the lithium secondary battery manufactured according to the method is 2.0 to 20.0 m²/g.

16. The method of claim 7, wherein a total pore volume of the anode active material for the lithium secondary battery manufactured according to the method is 0.03 to 0.06 cc/g.

17. The method of claim 7, wherein:
the depositing of the metal particles on the surface of the material doping and dedoping lithium includes
adding the material doping and dedoping lithium to an aqueous solution including a metal catalyst agent and hydrogen fluoride.

18. The method of claim 17, wherein a concentration of hydrogen fluoride is 1 to 10M.

19. The method of claim 17, wherein a concentration of the metal catalyst agent is 0.1 to 50 mM.

20. The method of claim 7, wherein:
the forming of the pores in the surface of the material doping and dedoping lithium by etching the surface on which the metal particles are deposited includes
adding the material doping and dedoping lithium, on the surface of which the metal particles are deposited, to an aqueous solution including hydrogen fluoride and an oxidant.

21. The method of claim 20, wherein a concentration of hydrogen fluoride is 1 to 10M.

22. The method of claim 20, wherein a concentration of the oxidant is 0.1 to 2M.

23. The method of claim 20, wherein the oxidant is H₂O₂, Fe NO₃₃, KMnO₄, or a combination thereof.
